(19) United States
(12) Patent Application Publication
(10) Pub. No.: US 2006/0160020 A1
(43) Pub. Date: Jul. 20, 2006

(54) Photosensitive polymer, photoresist composition having the photosensitive polymer and method of forming a photoresist pattern using the photoresist composition

(76) Inventors: Jina Ryu, Seoul (KR); Boo-Deuk Kim, Gyeonggi-do (KR); Jae-Ho Kim, Gyeonggi-do (KR); Young-Ho Kim, Gyeonggi-do (KR); Kyoung-Mi Kim, Gyeonggi-do (KR); Sangwoong Yoon, Seoul (KR)

Correspondence Address: MARGER JOHNSON & MCCOLLOM, P.C., 210 SW MORRISON STREET, SUITE 400, PORTLAND, OR, 97204, US

(21) Appl. No.: 11/334,018

(22) Filed: Jan. 17, 2006

(30) Foreign Application Priority Data
Jan. 17, 2005 (KR) 2005-04099

(51) Int. Cl. G03C 1/76

(52) U.S. Cl. 430/270.1

(57) ABSTRACT

A method can be provided of forming a photoresist pattern on a substrate. The method employs a photoresist composition comprising a photosensitive polymer, the photosensitive polymer has a molecular weight in a range of from about 1,000 up to about 100,000 and comprises repeating units having a structural formula: 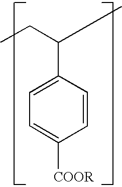 wherein R represents an acid-labile hydrocarbon group having from 1 up to 20 carbon atoms.

### CROSS REFERENCES TO RELATED APPLICATIONS

This application claims priority form Korean Patent Application No. 2005-4099 filed on Jan. 17, 2005, the content of which is herein incorporated by reference in its entirety.

### BACKGROUND OF THE INVENTION

1. Field of the Invention

The present invention relates to a photosensitive polymer, and more particularly, to a photosensitive polymer for forming a pattern for a semiconductor device, a photoresist composition having the photosensitive composition, and a photoresist pattern using the photoresist composition.

2. Description of the Related Art

Recently, as information media such as computers have become widely used, the semiconductor industry has made great strides in development of information media products. Functionally, semiconductor devices with a large storage capacity are required to operate at a very high speed. Accordingly, semiconductor technology has improved a degree of integration, reliability and response capability in order to increase an operation speed of the semiconductor devices. For those reasons, a photolithography process, which is a chief technique for fine patterning process to improve the integration degree of the semiconductor device, is required to satisfy more strict requirements.

The photolithography process is performed on a photoresist film comprising photoresist composition that is coated on a substrate. When light is irradiated onto the photoresist film, molecular structures of the photoresist film are selectively changed in accordance with the irradiated light by photochemical reactions thereon. Accordingly, the irradiated portion of the photoresist film is removed in a subsequent developing process due to a solubility difference with respect to a non-irradiated portion of the photoresist film, thereby forming a photoresist pattern on the substrate in accordance with a predetermined electronic circuit pattern on a reticle.

In general, a photoresist composition is classified as a positive type and a negative type in accordance with a molecular reaction to light irradiated thereto. When selected areas of the positive photoresist composition are exposed to light, high molecular compounds of the exposed portions are converted into low molecular compounds, which are more soluble to a developing solution than unexposed portions thereof. The exposed portions of the photoresist composition are readily removed from the substrate, thereby forming a photoresist pattern on the substrate in accordance with the exposed portions of the photoresist composition. In contrast, when selected areas of the negative photoresist composition are exposed to light, low molecular compounds are converted into high molecular compounds to thereby have lower solubility to a developing solution than unexposed portions. The unexposed portions of the photoresist composition are readily removed from the substrate, thereby forming a photoresist pattern on the substrate in accordance with the unexposed portions of the photoresist composition.

In general, the photoresist composition includes a polymer as a structural unit. A polymer for the photoresist composition is usually required to satisfy conditions of a high solubility in various solvents, a low optical density at a predetermined wavelength of light, a high thermal resistance, and a predetermined adherence.

A polymer material comprising cyclolefin-maleic anhydride (COMA) of which the structural formula is described below is disclosed in U.S. Pat. No. 5,843,624 as an example of the photosensitive polymer for a photoresist composition.

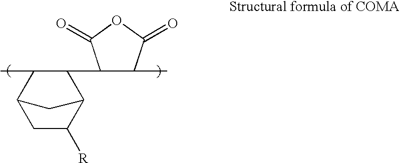

In general, a copolymer such as the above COMA is advantageous in that manufacturing cost is relatively low, but has a fatal problem of a low synthesis capability. In addition, the copolymer also has a low permeability when light of a short wavelength is irradiated thereto.

When a krypton fluoride (KrF) excimer laser is used as an illumination light in an exposing system, a compound based on polyhydroxystyrene (PHS) having a following structural formula can be used for the photoresist composition.

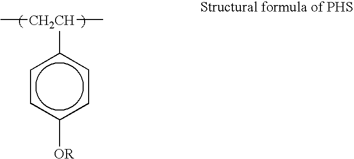

When the compound based on PHS is used as the photoresist composition, an acid (H+) liberated from the photo acid generator transforms the “—R” group into an “—OH” group in the above structural formula of PHS. As a result, the compound based on PHS is dissolved into a tetramethyl amomium hydroxide solution in a subsequent develop process.

A recent decreased design rule of a semiconductor device strongly requires an improved photoresist composition having a high resolution, so that intensive researches have been focused on maximizing a contrast of a photoresist composition. The contrast of the photoresist composition indicates a solubility difference between an exposed portion and an unexposed portion of the photoresist composition in a developing solution. The photoresist composition is formed to have a low solubility as much as possible, so that when a portion of the photoresist composition is exposed by light, the solubility difference between the exposed portion and the unexposed portion becomes high, thereby increasing the contrast of the photoresist composition. The control on the solubility of the photoresist composition is performed by changing a blocking group such as the “—R” group in the structural formula of PHS or a blocking ratio. However, a change of the blocking group or the blocking ratio does not sufficiently improve the contrast of the photoresist composition, and what is worse the change of the blocking group or the blocking ratio causes various processing failures when performing a patterning process.

Accordingly, there has been still required an improved photoresist composition having a superior reproducibility and a high resolution.

### SUMMARY

Accordingly, some embodiments of the present invention provides a photosensitive polymer having a high resolution.

The present invention also provides a photoresist composition including the above photosensitive polymer.

The present invention still also provides a method of forming a photoresist pattern comprising the above photoresist composition.

According to an aspect of the present invention, a photoresist composition is provided. The photoresist composition comprises a photo acid generator (PGA), an organic solvent, and a photosensitive polymer. The photosensitive polymer can have a molecular weight in a range of from about 1,000 to about 100,000, preferably in a range from about 5,000 to about 50,000. The photosensitive polymer can also comprise repeating units having the structural formula:

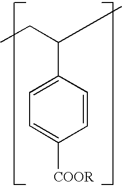

wherein R represents an acid-labile hydrocarbon group having from 1 up to 20 carbon atoms. The acid-labile hydrocarbon group is preferably selected from the group consisting of a t-butyl group, a tetrahydro pyranyl group and a 1-ethoxy ethyl group. Furthermore, the acid-labile hydrocarbon group preferably includes a third order aliphatic cyclic hydrocarbon group having from 6 to 20 carbon atoms.

The PGA is preferably in an amount from about 0.1 up to about 15 parts by weight, based on 100 parts by weight of photosensitive polymer. More preferably, the PGA selected from the group consisting of sulfonium salt, triarylsulfonium salt, iodonium salt, diaryliodonium salt, nitrobenzyl ester, disulfone, diazo-disulfone, sulfonate, trichloromethyl triazine, N-hydroxysuccinimide triflate, and combinations thereof. The organic solvent is preferably selected from the group consisting of ethyleneglycolmonomethylether, ethyleneglycolmonoethylether, methylcellosolveacetate, ethylcellosolveacetate, diethyleneglycolmonomethylether, diethyleneglycolmonoethylether, propyleneglycolmethyletheracetate, propyleneglycolpropyletheracetate, diethyleneglycoldimethylether, ethyl lactate, toluene, xylene, methylethylketone, cyclohexanone, 2-heptanone, 3-heptanone, 4-heptanone, and combinations thereof.

The photoresist composition preferably includes an organic base. The amount of the organic base is from about 0.01 up to about 20 parts by weight, based on 100 parts by weight of photosensitive polymer. The organic base is preferably selected from the group consisting of triethylamine, triisobutylamine, triisooctylamine, triisodecylamine, diethanolamine, triethanolamine, and combinations thereof.

A method can also be provided of forming a photoresist pattern on an object. The method comprises forming a photoresist film on the object using a photoresist composition, the photoresist composition comprising a photo acid generator, an organic solvent, and a photosensitive polymer as described above, partially exposing the photoresist film to light using a mask over the object, and removing a portion of the photoresist film from the object, thereby forming said photoresist pattern on the object. The light preferably comprises one of a G-line ray, an I-line ray, a KrF excimer laser, an ArF excimer laser, an electron beam (e-beam) and an X-ray.

According to some embodiments of the present invention, when a photoresist film comprises a photoresist composition including a photosensitive polymer of the present invention, a solubility difference between an exposed and an unexposed portion of the photoresist film is maximized. As a result, a finer pattern is formed on the substrate and an edge roughness of the pattern is minimized. A process failure of a semiconductor device is minimized, thereby improving productivity of the semiconductor device.

### BRIEF DESCRIPTION OF THE DRAWINGS

The above and other features and advantages of the present invention will become readily apparent by reference to the following detailed description when considering in conjunction with the accompanying drawings, in which:

FIGS. 1 to 3 are cross sectional views illustrating processing steps for a method of forming a photoresist pattern according to an exemplary embodiment of the present invention;

FIG. 4 is a graph comparing the solubility of photoresist films versus an exposure dose;

FIG. 5 is a perspective view illustrating a comparative example photoresist pattern;

FIG. 6 is a view analytically illustrating the comparative example photoresist pattern shown in FIG. 5;

FIG. 7 is a perspective view illustrating a further example photoresist pattern; and

FIG. 8 is a view analytically illustrating the example photoresist pattern shown in FIG. 7.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Photosensitive Polymer

A photosensitive polymer of the present embodiment comprises repeating units which have a structural formula which is described below as structural formula 1. Typically, this photosensitive polymer has a molecular weight of from about 1,000 up to about 100,000.
Structural Formula 1

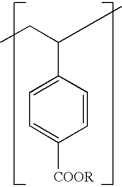

In structural formula 1, “R” represents an acid-labile hydrocarbon group having from 1-to 20 carbon atoms.

The photosensitive polymer may be synthesized employing the following chemical reactions.

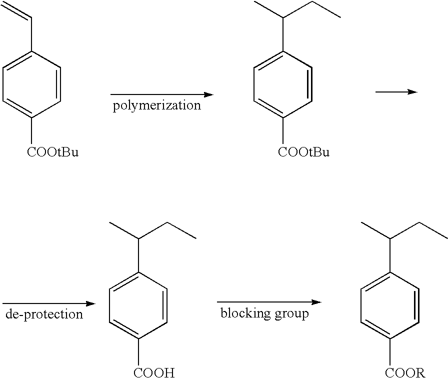

When light is irradiated onto a photoresist film comprising the photoresist composition including the photosensitive polymer, an acid (H+) is liberated from a PGA in the photoresist composition and the acid (H+) is reacted with the “—COOR” group in the photosensitive polymer. Accordingly, the repeating unit of the photosensitive polymer is changed as shown in the following structural formula 2.
Structural Formula 2

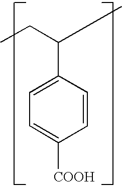

When a conventional photosensitive polymer based on a polystyrene compound is exposed by light, a pKa value of the conventional photosensitive polymer is about 9.9. In contrast, when the photosensitive polymer of the present invention is exposed by light, a pKa value of the photosensitive polymer is about 4.1. As a result, the acidity of the photosensitive polymer of the present invention is about 105.8 times as much as that of the conventional photosensitive polymer.

In structural formula 1, “R” represents an acid-labile hydrocarbon such as t-butyl group, tetrahydropyranyl group and 1-ethoxy ethyl group. The “R” in structural formula 1 may also comprise a third order aliphatic cyclic hydrocarbon group having 6-20 carbon atoms.

When a photoresist composition comprising a photosensitive polymer of which the molecular weight is less than about 5,000 is used for a photoresist film, the photoresist film is generally not formed at a sufficient thickness on a substrate. When a photoresist composition comprising a photosensitive polymer of which the molecular weight is more than about 50,000 is used for a photoresist film, the photoresist film is difficult to dissolve in a developing solution, so that a scum occurs in the photoresist film. Accordingly, in some embodiments, the photosensitive polymer has a molecular weight of from about 5,000 up to about 50,000, and more particularly, a molecular weight of from about 10,000 up to about 20,000.

Photoresist Composition

A photosensitive polymer of the present invention can also comprise a photosensitive polymer of the structural formula which is described below as structural formula 3. The photosensitive polymer also can have a molecular weight range of from about 1,000 to about 100,000, a photo acid generator (PGA) and an organic solvent.
Structural Formula 3

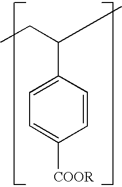

In structural formula 3, “R” represents an acid-labile hydrocarbon group having from 1 up to 20 carbon atoms. Examples of the acid-labile hydrocarbon group can include a t-butyl group, a tetrahydropyranyl group and a 1-ethoxy ethyl group. The “R” in structural formula 1 may also denote a third order aliphatic cyclic hydrocarbon group having from 6 up to 20 carbon atoms.

The photosensitive polymer can also have a molecular weight of from about 5,000 up to about 50,000, and more particularly, of from about 10,000 up to about 20,000. The photosensitive polymer has been already described in the above, so any further detailed description on the photosensitive polymer is omitted.

When the photoresist composition comprises a PGA of less than about 0.1 parts by weight based on 100 parts by weight of photosensitive polymer, an amount of the acid (H+) liberated from the PGA is not sufficient, so that a developing rate in a subsequent developing process is significantly reduced. When the photoresist composition comprises a PGA more than about 15 parts by weight based on 100 parts by weight of photosensitive polymer, light is excessively absorbed by PGA and a bottom portion of a photoresist film is not sufficiently exposed by the light. Therefore, the bottom portion of the photoresist film is not patterned. Accordingly, the photoresist composition in some embodiments of the present invention comprises a PGA in a range from about 0.1 up to about 15 parts by weight based on 100 parts by weight of photosensitive polymer.

Examples of the PGA preferably include sulfonium salt, triarylsulfonium salt, iodonium salt, diaryliodonium salt, nitrobenzyl ester, disulfone, diazo-disulfone, sulfonate, trichloromethyl triazine, N-hydroxysuccinimide triflate, etc. These can be used alone or in combinations thereof.

In particular, examples of the PGA more preferably include triphenylsulfonium triflate, triphenylsulfonium antimony salt, diphenyliodonium triflate, diphenyliodonium antimony salt, methoxydiphenyliodonium triflate, di-tert-butyldiphenyliodonium triflate, 2,6-dinitrobenzyl sulfonate, pyrogallol tris(alkylsufonate), norbornene-dicarboxyimide triflate, triphenylsufonium nonaflate, diphenyliodonium nonaflate, methoxydiphenyliodonium nonaflate, di-tert-butyldiphenyliodonium nonaflate, N-hydroxysuccinimide nonaflate, norbornene dicarboxyimide nonaflate, triphenylsulfonium perfluorooctanesulfonate, diphenyliodonium perfluorooctanesulfonate, methoxyphenyliodonium perfluorooctanesulfonate, di-tert-butyldiphenyliodonium triflate, N-hydroxysuccinimide perfluorooctanesulfonate, norbornene dicarboxyimide perfluorooctanesulfonate, etc. These can be also used alone or in combinations thereof.

Examples of the organic solvent preferably include ethyleneglycolmonomethylether, ethyleneglycolmonoethylether, methylcellosolveacetate, ethylcellosolveacetate, diethyleneglycolmonomethylether, diethyleneglycolmonoethylether, propyleneglycolmethyletheracetate, propyleneglycolpropyletheracetate, diethyleneglycoldimethylether, ethyl lactate, toluene, xylene, methylethylketone, cyclohexanone, 2-heptanone, 3-heptanone, 4-heptanone, etc. These can be also used alone or in combinations thereof.

In some embodiments of the present invention, the photoresist composition further includes an organic base. The organic base can minimize the effect of base complexes in the air, such as amine base on a photoresist pattern. It can also control the shape of the pattern.

When the photoresist composition comprises the organic base which is less than about 0.01 parts by weight based on 100 parts by weight of photosensitive polymer, the photoresist pattern is difficult to be accurately formed into a desirable shape. When the photoresist composition comprises the organic base more than about 20 parts by weight based on 100 parts by weight of photosensitive polymer, the cost for the photoresist pattern is very high, so that the amount of the organic base is not recommended from an economic point of view. Accordingly, the photoresist composition in some embodiments of the present invention can comprise an organic base in a range from about 0.01 up to about 20 parts by weight based on 100 parts by weight of photosensitive polymer.

Examples of the organic base can include triethylamine, triisobutylamine, triisooctylamine, triisodecylamine, diethanolamine, triethanolamine, etc. These can be used alone and in combinations thereof.

In addition, the photoresist composition may further include various additives such as a surfactant, a sensitizer, an adhesive and a reservation stabilizer. Examples of the surfactant can include an ether compound such as polyoxyethylene lauryl ether, polyoxyethylene stearyl ether, polyoxyethylene oleyl ether and polyoxyethylene nonyl phenyl ether. Although an exemplary surfactant of the present invention has been described above, the present surfactant should not be limited to those examples. An amine compound may be used as the sensitizer, the adhesives and the reservation stabilizer. The photoresist composition in some embodiments of the present invention comprises each of the additives are preferably no more than about 5 parts by weight based on 100 parts by weight of photosensitive polymer.

Method of Forming a Photoresist Pattern

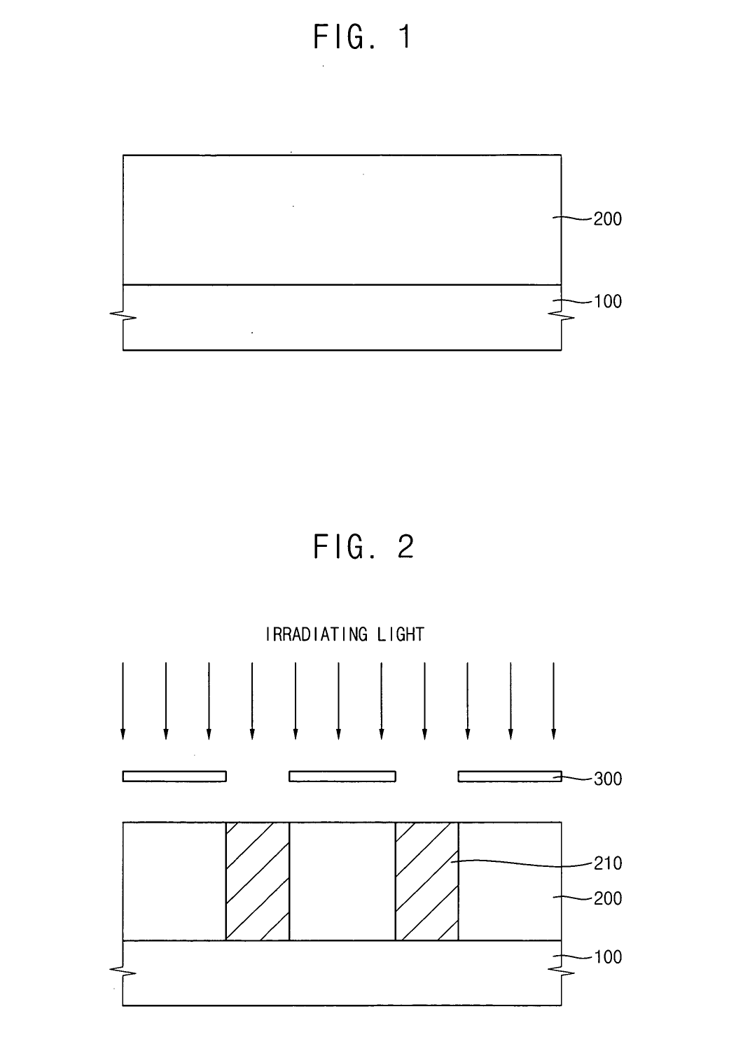

FIGS. 1 to 3 are cross sectional views illustrating processing steps for a method of forming a photoresist pattern according to an example embodiment of the present invention.

Referring to FIG. 1, an object on which a photoresist pattern is formed is prepared. In the present embodiment, a substrate 100 such as a silicon wafer is used as the object, and a predetermined structure may be formed on the substrate 100. A surface treatment may be performed on a surface of the substrate, so that vapor and contaminants may be removed from the substrate 100, thereby improving adhesive property between the substrate 100 and a photoresist film thereon. In the present embodiment, a rotary fiber brush can make contact with a surface of the substrate 100 secured to a rotary chuck, and the rotary fiber brush can rotate at a high speed on the surface of the substrate 100 in an opposite rotation direction of the substrate 100, thereby removing contaminants on the surface of the substrate 100.

A photoresist composition is deposited onto the surface of the substrate 100, thereby forming a photoresist film 200 on the substrate 100. The photoresist composition comprises a photosensitive polymer having the same structural formula as structural formula 3 and having a molecular weight in a range from about 1,000 up to about 100,000, a photo acid generator (PGA) and an organic solvent. In some embodiments of the present invention, the photoresist film may be formed by a spin coating process. In particular, the substrate 100 is secured to a rotary chuck and rotates at a high speed. The photoresist composition is uniformly coated on a surface of the rotating substrate 100, thereby forming the photoresist film 200 on the substrate 100. In addition, an anti-reflective layer (not shown) may be further formed on the photoresist film 200. In the structural formula of the photosensitive polymer, “R” also represents an acid-labile hydrocarbon group having from 1 up to 20 carbon atoms. Examples of the acid-labile hydrocarbon group can include a t-butyl group, a tetrahydropyranyl group and a 1-ethoxy ethyl group. The “R” also denotes a third order aliphatic cyclic hydrocarbon group having from 6 up to 20 carbon atoms.

The photosensitive polymer has a molecular weight of from about 5,000 up to about 50,000, and more particularly, of from about 10,000 up to about 20,000. The PGA and the organic solvent have been already described in the above, so any further detailed description on the PGA and the organic solvent is omitted.

The substrate 100 including the photoresist film 200 can then be heated at a temperature of from about 90° C. up to about 120° C., thereby performing a first baking process on the substrate 100. The first baking process removes the organic solvent from the photoresist film, thereby improving the adhesive property of the photoresist film 200 to the substrate 100.

Referring to FIG. 2, an exposure process is performed on the photoresist film 200. In particular, a mask 300 on which an electric circuit pattern is formed is positioned on a mask stage of an exposure system, and is aligned over the substrate 100 on which the photoresist film 200 is formed. Light passes through the mask 300 for a predetermined time and a surface of the photoresist film is partially exposed by the light having passed though the mask in accordance with the electric circuit pattern on the mask 300. The light in the exposure system can include a G-line ray, an I-line ray, a KrF excimer laser, an ArF excimer laser, an electron beam (e-beam) and an X-ray. The solubility of an exposed portion of the photoresist film is different from that of an unexposed portion of the photoresist film.

A second baking process may be selectively performed on the substrate 100 at a temperature of about 90° C. up to about 120° C., so that the exposed portion 210 of photoresist film 200 becomes readily soluble in a predetermined develop solution.

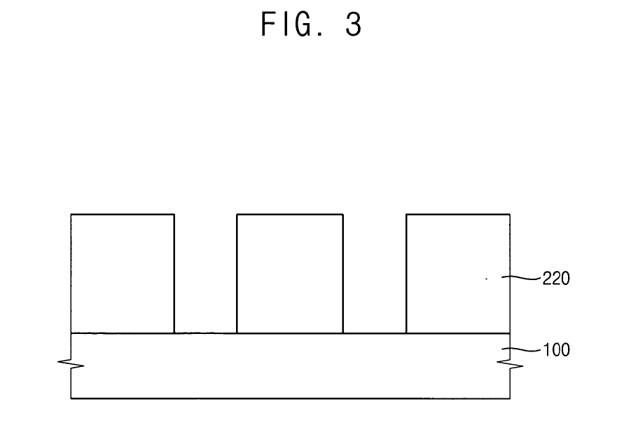

Referring to FIG. 3, the exposed portion 210 of the photoresist portion of the photoresist film 200 is removed from the substrate 100, thereby forming a photoresist pattern 220 on the substrate 100. In particular, when the photoresist film is a positive type, the exposed portion 210 of the photoresist film 200 is dissolved into a develop solution of tetra-methyl ammonium hydroxide (TMAH), thereby forming the photoresist pattern 220 on the substrate 100.

Thereafter, additional processes such as a cleaning process may be performed on the substrate 100 including the photoresist pattern 220. Various semiconductor structures may also be formed on the substrate 100 using the photoresist pattern 220 as an etching mask.

An experiment on characteristics of photoresist film comprising the photoresist composition of the present invention was conducted using following example and comparative example.

### EXAMPLE

The example of the photoresist composition comprised about 10% by weight of photosensitive polymer, about 0.1% by weight of sulfonate as photo acid generator, about 0.05% by weight of trimethyl amine, which was a trialkylamine, as organic base and about 89.85% by weight of propyleneglycolmethylether as organic solvent. The photosensitive polymer had a molecular weight of about 12,000.

### Comparative Example

The comparative example of the photoresist composition, which was a conventional photoresist composition, comprised about 10% by weight of polyhydroxystyrene (PHS) resin as photosensitive polymer, about 0.1% by weight of sulfonate as photo acid generator, about 0.05% by weight of trimethyl amine, which was a trialkylamine, as organic base and about 89.85% by weight of propyleneglycolmethylether as organic solvent. The photosensitive polymer had a molecular weight of about 12,000.

Experiment on Solubility of a Photoresist Film

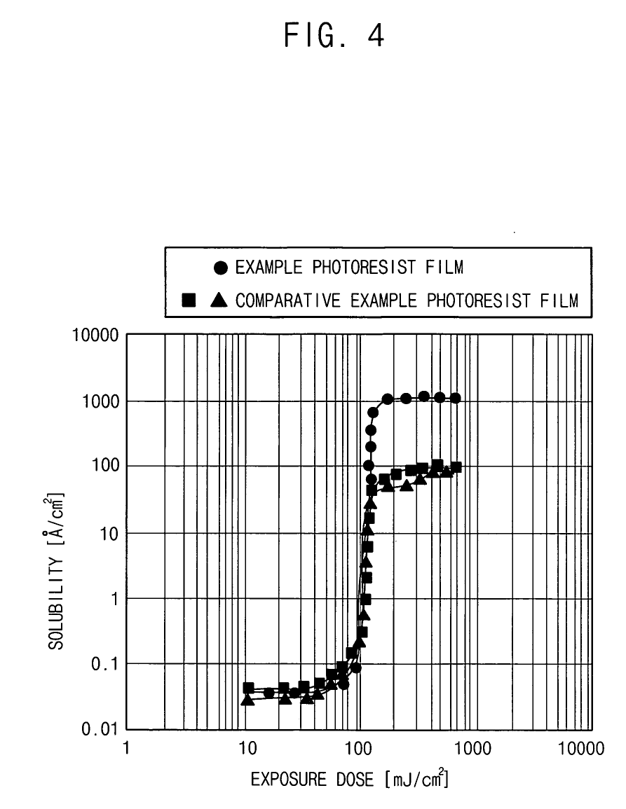

An example photoresist film and a comparative example photoresist film were formed on a substrate to a thickness of about 45,000 Å by depositing the example photoresist composition and comparative photoresist composition onto the substrate, respectively. Then, each of the photoresist films was exposed by KrF excimer laser, and developed using TMAH solution of which concentration was about 2.38%. A solubility of each photoresist film in the above TMAH solution was detected as shown in FIG. 4.

FIG. 4 is a graph showing a solubility of each photoresist film in relation with an exposure dose.

As shown in FIG. 4, the solubility of the example photoresist film was higher than that of the comparative example photoresist film. In particular, when the exposure dose was about 100 mJ/cm2, the solubility of the example photoresist film was significantly higher, about 10 times higher, than that of the comparative example photoresist film. Accordingly, FIG. 4 indicates that a solubility of a photoresist film in a develop solution may increase by using the photoresist composition of the present invention, thereby maximizing a contrast of the photoresist film and improving a resolution of a photoresist pattern.

Experiment on Resolution of a Photoresist Pattern

An example photoresist film and a comparative example photoresist film were formed on a substrate to a thickness of about 45,000 Å by depositing the example photoresist composition and comparative photoresist composition onto the substrate, respectively. Then, each of the photoresist films was exposed by KrF excimer laser, and developed using TMAH solution of which concentration was about 2.38%.

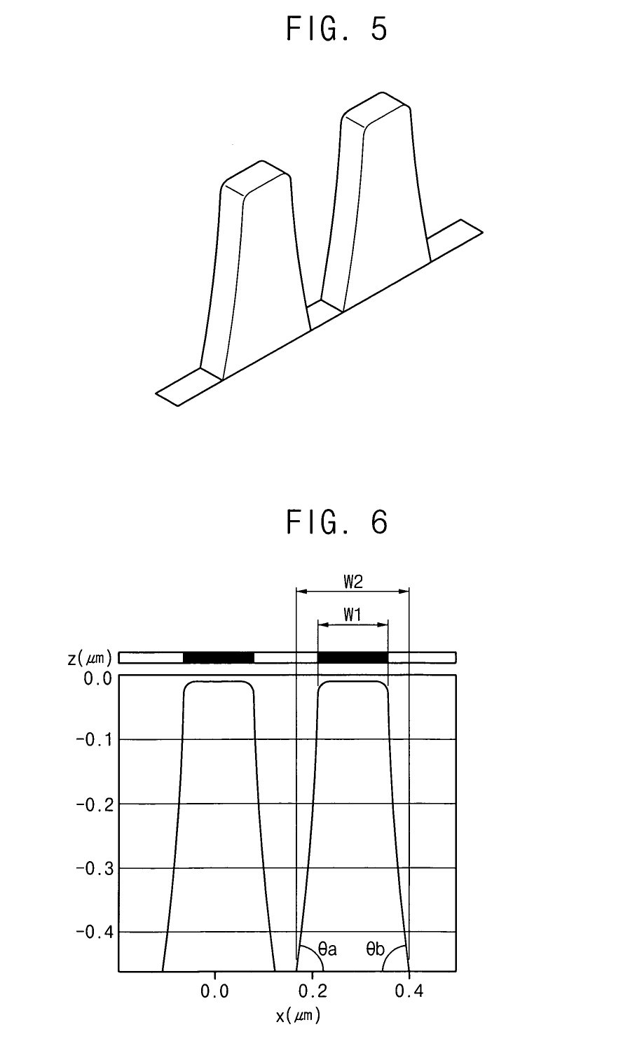

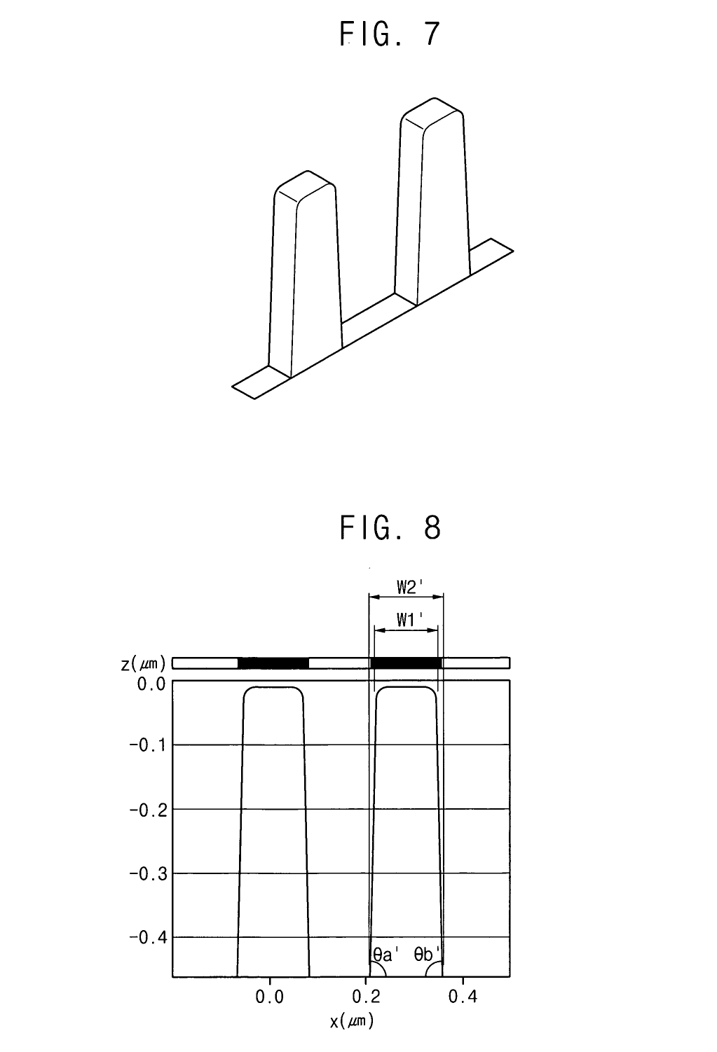

FIG. 5 is a perspective view illustrating the comparative example photoresist pattern, and FIG. 6 is a view analytically illustrating the comparative example photoresist pattern shown in FIG. 5. FIG. 7 is a perspective view illustrating the example photoresist pattern, and FIG. 8 is a view analytically illustrating the example photoresist pattern shown in FIG. 7.

Referring to FIGS. 5 and 6, upper width W1 and lower width W2 of the comparative example photoresist pattern were about 0.151 μm and about 0.182 μm, respectively. An average sidewall angle, which was determined as an arithmetic average of a right sidewall angle θa and a left sidewall angle θb, was about 86.0°.

Referring to FIGS. 7 and 8, upper width W1′ and lower width W2′ of the example photoresist pattern were about 0.116 μm and about 0.134 μm, respectively. An average sidewall angle, which was determined as an arithmetic average of a right sidewall angle θa′ and a left sidewall angle θb′, was about 87.7°.

While a width difference between the upper and lower widths was about 0.018 μm in case of the example photoresist pattern, the width difference was about 0.031 μm in case of the comparative example pattern. Accordingly, FIGS. 5 to 8 indicate that the width difference is significantly reduced in the example photoresist pattern as compared with the comparative example of the photoresist pattern. In addition, FIGS. 5 to 8 also indicate that the average sidewall angle also increases in the example photoresist pattern as compared with the comparative example photoresist pattern.

As a result, when a photoresist film comprises a photoresist composition of the present invention, a photoresist pattern of high resolution may readily be formed on a substrate, so that a finer semiconductor structure may be formed on the substrate using the high resolution photoresist pattern as an etching mask.

According to the present invention, when a photoresist film comprises a photoresist composition including a photosensitive polymer of the present invention, a solubility difference between an exposed and an unexposed portion of the photoresist film is maximized. As a result, a finer pattern is formed on the substrate and an edge roughness of the pattern is minimized. A process failure of a semiconductor device is minimized, thereby improving productivity of the semiconductor device.

Although the exemplary embodiments of the present invention have been described, it is understood that the present invention should not be limited to these exemplary embodiments but various changes and modifications can be made by one skilled in the art within the spirit and scope of the present invention as hereinafter claimed.

What is claimed is:

1. A photosensitive polymer having a molecular weight in a range from about 1,000 to about 100,000 and comprising repeating units having the structural formula: 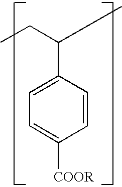
wherein R represents an acid-labile hydrocarbon group having from 1 to 20 carbon atoms.

2. The photosensitive polymer of claim 1, wherein the acid-labile hydrocarbon group is selected from the group consisting of a t-butyl group, a tetrahydro pyranyl group and a 1-ethoxy ethyl group.

3. The photosensitive polymer of claim 1, wherein the acid-labile hydrocarbon group includes a third order aliphatic cyclic hydrocarbon group having from 6 to 20 carbon atoms.

4. The photosensitive polymer of claim 1, wherein the molecular weight ranges from about 5,000 to about 50,000.

5. A photoresist composition comprising:
a photo acid generator (PGA);
an organic solvent; and
a photosensitive polymer having a molecular weight in a range of from about 1,000 to about 100,000 and comprising repeating units having the structural formula: 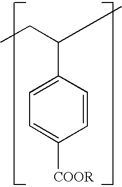
wherein R represents an acid-labile hydrocarbon group having from 1 up to 20 carbon atoms.

6. The photoresist composition of claim 5, wherein the acid-labile hydrocarbon group is selected from the group consisting of a t-butyl group, a tetrahydro pyranyl group and a 1-ethoxy ethyl group.

7. The photoresist composition of claim 5, wherein the acid-labile hydrocarbon group includes a third order aliphatic cyclic hydrocarbon group having from 6 up to 20 carbon atoms.

8. The photoresist composition of claim 5, wherein the photosensitive polymer has a molecular weight in a range from about 5,000 to about 50,000.

9. The photoresist composition of claim 5, wherein the PGA is in an amount from about 0.1 up to about 15 parts by weight, based on 100 parts by weight of photosensitive polymer.

10. The photoresist composition of claim 5, wherein the PGA is selected from the group consisting of sulfonium salt, triarylsulfonium salt, iodonium salt, diaryliodonium salt, nitrobenzyl ester, disulfone, diazo-disulfone, sulfonate, trichloromethyl triazine, N-hydroxysuccinimide triflate, and combinations thereof.

11. The photoresist composition of claim 5, wherein the organic solvent is selected from the group consisting of ethyleneglycolmonomethylether, ethyleneglycolmonoethylether, methylcellosolveacetate, ethylcellosolveacetate, diethyleneglycolmonomethylether, diethyleneglycolmonoethylether, propyleneglycolmethyletheracetate, propyleneglycolpropyletheracetate, diethyleneglycoldimethylether, ethyl lactate, toluene, xylene, methylethylketone, cyclohexanone, 2-heptanone, 3-heptanone, 4-heptanone, and combinations thereof.

12. The photoresist composition of claim 5, which further comprises an organic base.

13. The photoresist composition of claim 12, wherein the amount of the organic base is from about 0.01 up to about 20 parts by weight, based on 100 parts by weight of photosensitive polymer.

14. The photoresist composition of claim 12, wherein the organic base is selected from the group consisting of triethylamine, triisobutylamine, triisooctylamine, triisodecylamine, diethanolamine, triethanolamine, and combinations thereof.

15. A method of forming a photoresist pattern on an object, comprising:
forming a photoresist film on the object using a photoresist composition, the photoresist composition comprising a photo acid generator, an organic solvent, and a photosensitive polymer having a molecular weight in a range of from about 1,000 up to about 100,000 and comprising repeating units having a structural formula: 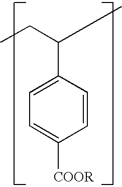
wherein R represents an acid-labile hydrocarbon group having from 1 up to 20 carbon atoms;
partially exposing the photoresist film to light using a mask over the object; and
removing a portion of the photoresist film from the object, thereby forming said photoresist pattern on the object.

16. The method of claim 15, wherein the acid-labile hydrocarbon group is selected from the group consisting of a t-butyl group, a tetrahydro pyranyl group and a 1-ethoxy ethyl group.

17. The method of claim 15, wherein the acid-labile hydrocarbon group includes a third order aliphatic cyclic hydrocarbon group having from 6 up to 20 carbon atoms.

18. The method of claim 15, wherein the photosensitive polymer has a molecular weight in a range of from about 5,000 up to about 50,000.

19. The method of claim 15, wherein the light comprises one of a G-line ray, an I-line ray, a KrF excimer laser, an ArF excimer laser, an electron beam (e-beam) and an X-ray.
